(19) United States
(12) Patent Application Publication
(10) Pub. No.: US 2019/0230728 A1
(43) Pub. Date: Jul. 25, 2019

(54) WIRELESS COMMUNICATION DEVICE AND COMMUNICATION PAIRING METHOD THEREOF

(71) Applicant: Primax Electronics Ltd., Taipei (TW)

(72) Inventors: Chih-Feng CHIEN, Taipei (TW); Chien-Nan LIN, Taipei (TW)

(21) Appl. No.: 16/002,969

(22) Filed: Jun. 7, 2018

(30) Foreign Application Priority Data
Jan. 19, 2018 (TW) 107102086

(51) Int. Cl. H04W 76/14; G06F 3/038

(52) U.S. Cl. CPC H04W 76/14; G06F 2203/0384; G06F 3/038

(57) ABSTRACT

A wireless communication device includes a device body, a wireless radio frequency receiver and a paring program. The device body includes a wireless radio frequency transmission module and a Bluetooth transmission module. The wireless radio frequency receiver is connected with a host and receives a wireless radio frequency signal from the wireless radio frequency transmission module. A device descriptor about the device body is stored in the wireless radio frequency receiver. The paring program is installed in the host. The paring program performs a Bluetooth communication pairing process of pairing the Bluetooth transmission module with the host according to the device descriptor and a broadcasting information from the device body.

### FIELD OF THE INVENTION

The present invention relates to a field of wireless communication, and more particularly to a wireless communication device and a communication pairing method thereof.

### BACKGROUND OF THE INVENTION

With increasing development of science and technology, various wireless communication devices such as wireless mouse devices, wireless keyboards, wireless graphics boards or wireless microphones are widely used in daily lives. In comparison with the wired communication devices, the uses of the wireless communication devices can reduce the cost of cables (or connecting wires). Moreover, the uses of the wireless communication devices can reduce the storage space and increase the operating distance. Recently, the wired communication devices are gradually replaced by the wireless communication devices.

For enhancing the operating utilization, a wireless communication device is possibly operated in various communication modes. The communication modes of the wireless communication device can be selected by the user. FIG. 1 is a schematic functional block diagram illustrating the architecture of a wireless mouse according to the prior art. As shown in FIG. 1, the wireless mouse 3 comprises a mouse body 31 and a wireless radio frequency receiver 32. The wireless radio frequency receiver 32 is plugged into a universal serial bus connection port 41 of a computer 4. Moreover, the wireless radio frequency receiver 32 receives a wireless radio frequency signal S2 from the mouse body 31. The mouse body 31 comprises a wireless radio frequency transmission module 311 and a Bluetooth transmission module 312, which are operated according to a 2.4 GHz wireless transmission technology. When the mouse body 31 is operated in a wireless radio frequency communication mode, the wireless radio frequency signal S2 is transmitted from the mouse body 31 to the wireless radio frequency receiver 32 to control the computer 4. For example, a cursor is moved or a key command is executed according to the wireless radio frequency signal S2. When the mouse body 31 is operated in a Bluetooth communication mode, the mouse body 31 is in Bluetooth connection with the computer 4 through the Bluetooth transmission module 312 to transmit a Bluetooth signal to the computer 4. The computer 4 is controlled according to the Bluetooth signal. The mouse body 31 is selectively in the wireless radio frequency communication mode or the Bluetooth communication mode according to the practical requirements of the user.

Before the Bluetooth connection between the mouse body 31 and the computer 4 is established, a Bluetooth pairing communication process is necessary to pair the mouse body 31 with the computer 4. That is, the user has to look up the instructions of the wireless mouse 3 to realize the device name of the wireless mouse 3 and enables the Bluetooth device of the computer 4 to select the device name of the wireless mouse 3. Consequently, the Bluetooth pairing between the mouse body 31 and the computer 4 is established. After the Bluetooth pairing communication process is completed, the Bluetooth connection between the mouse body 31 and the computer 4 is established. However, the pairing process requires the manual operating behavior of the user. That is, if the user does not look up the instructions of the wireless mouse 3 to realize the device name of the wireless mouse 3 or the user does not enable the Bluetooth device search function of the computer and select the device name of the wireless mouse 3, the Bluetooth pairing communication process of pairing the mouse body 31 to the computer 4 cannot be completed. As mentioned above, the Bluetooth pairing communication process is complicated and inconvenient to the user. In other words, the conventional wireless communication device needs to be further improved.

### SUMMARY OF THE INVENTION

An object of the present invention provides a wireless communication device. A Bluetooth communication pairing process of paring the wireless communication device with the host is automatically executed according to a device descriptor from a wireless radio frequency receiver of the wireless communication device.

Another object of the present invention provides a communication pairing method for automatically pairing the wireless communication device with the host.

In accordance with an aspect of the present invention, there is provided a wireless communication device. The wireless communication device includes a device body, a wireless radio frequency receiver and a paring program. The device body includes a wireless radio frequency transmission module and a Bluetooth transmission module. The wireless radio frequency receiver is connected with a host and receives a wireless radio frequency signal from the wireless radio frequency transmission module. A device descriptor about the device body is stored in the wireless radio frequency receiver. The paring program is installed in the host. After the wireless radio frequency receiver is connected with the host, the paring program is executed to actively read the device descriptor from the wireless radio frequency receiver and judge whether the Bluetooth transmission module has been paired with the host according to the device descriptor. If the paring program judges that the Bluetooth transmission module has not been paired with the host, the paring program performs a Bluetooth communication pairing process of pairing the Bluetooth transmission module with the host according to the device descriptor and a broadcasting information from the device body.

In accordance with another aspect of the present invention, there is provided a communication pairing method for pairing a device body of a wireless communication device with a host. The communication pairing method includes the following steps. In a step (a), a device descriptor about a wireless communication device is stored into a wireless radio frequency receiver of the wireless communication device. The wireless radio frequency receiver receives a wireless radio frequency signal from the device body. In a step (b), the device descriptor is read from the wireless radio frequency receiver when the wireless radio frequency receiver is connected with the host. Then, a step (c) is performed to judge whether a Bluetooth communication pairing process of paring the device body with the host has been successfully done according to the device descriptor. In a step (d), if the Bluetooth communication pairing process of paring the device body with the host has not been successfully done, the Bluetooth communication pairing process of paring the device body with the host is performed according to the device descriptor and a broadcasting information from the device body.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating the architecture of a wireless mouse according to the prior art;

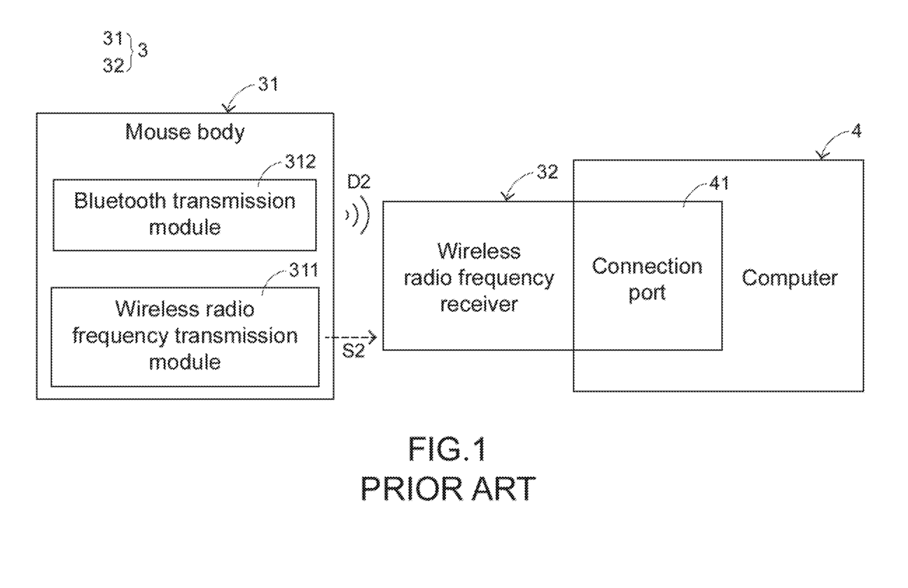

FIG. 2 is a schematic functional block diagram illustrating the architecture of a wireless communication device according to an embodiment of the present invention; and

FIG. 3 is a flowchart illustrating a communication pairing method according to an embodiment of the present invention.

### DETAILED DESCRIPTION OF THE PREFERRED EMBODIMENT

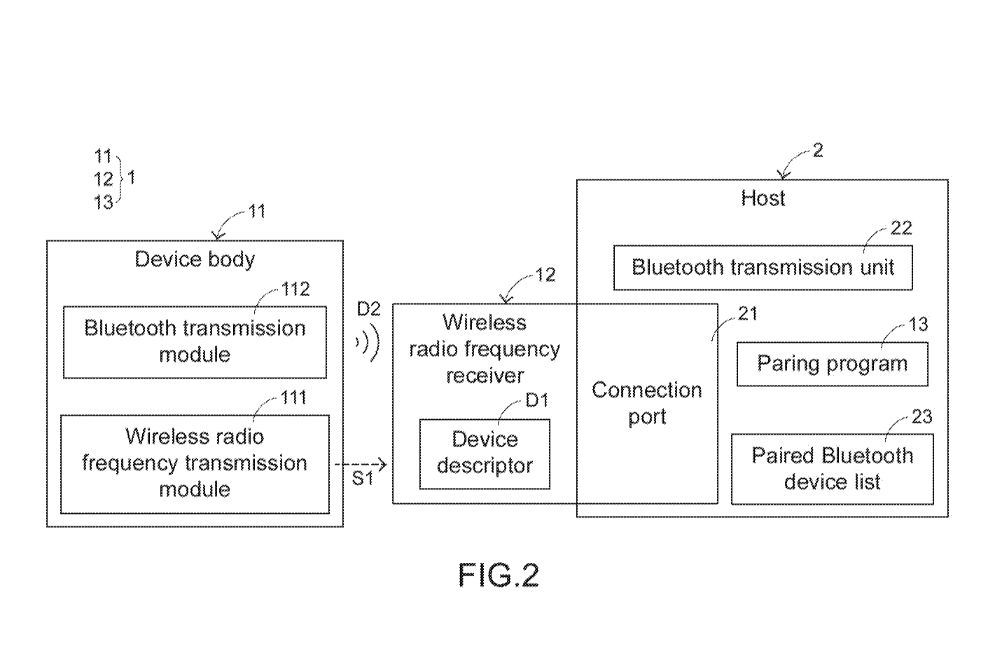

FIG. 2 is a schematic functional block diagram illustrating the architecture of a wireless communication device according to an embodiment of the present invention. The wireless communication device 1 is in wireless communication with a host 2. The host 2 is an electronic device with any software execution function or a programmable logic operation function. An example of the host 2 includes but is not limited to a desktop computer, a notebook computer or a tablet computer. An example of the wireless communication device 1 includes but is not limited to a mouse device, a keyboard device, a writing tablet, a camera device, a wearable device or any other device with specified application functions.

The host 2 comprises at least one connection port 21 and a Bluetooth transmission unit 22. The wireless communication device 1 comprises a device body 11, a wireless radio frequency receiver 12 and a paring program 13. The device body 11 comprises a wireless radio frequency transmission module 111 and a Bluetooth transmission module 112. When the device body 11 is operated in a wireless radio frequency communication mode, the device body 11 performs the wireless radio frequency communication through the wireless radio frequency transmission module 111. When the device body 11 is operated in a Bluetooth communication mode, the device body 11 performs the Bluetooth communication through the Bluetooth transmission module 112. The wireless radio frequency receiver 12 is connected with the host 2 through the connection port 21 of the host 2. Moreover, the wireless radio frequency receiver 12 receives a wireless radio frequency signal S1 from the wireless radio frequency transmission module 111 of the wireless communication device 1. Consequently, the wireless radio frequency communication between the device body 11 of the wireless communication device 1 and the host 2 is established.

In an embodiment, the connection port 21 of the host 2 is a universal serial bus (USB) connection port. The wireless radio frequency receiver 12 of the wireless communication device 1 is a USB dongle that is plugged into the USB connection port. Preferably but not exclusively, the wireless radio frequency transmission module 111 of the device body 11 is a 2.4G wireless transmission module. Preferably but not exclusively, the Bluetooth transmission module 112 of the device body 11 is a Bluetooth low energy (BLE) transmission module. The way of establishing the wireless radio frequency communication between the device body 11 of the wireless communication device 1 and the host 2 through the wireless radio frequency receiver 12 of the wireless communication device 1 is well known to those skilled in the art, and is not redundantly described herein.

As mentioned above, the wireless radio frequency receiver 12 of the wireless communication device 1 receives the wireless radio frequency signal S1 from the wireless radio frequency transmission module 111 of the wireless communication device 1. In addition, a device descriptor D1 about the device body 11 of the wireless communication device 1 is stored in the wireless radio frequency receiver 12. Preferably but not exclusively, the device descriptor D1 includes a vendor identification code (VID) of the wireless communication device 1, a product identification code (PID), a product string, a serial number, a vendor-defined protocol, a Bluetooth (BT) address, or any other recognizable information.

The paring program 13 is installed in the host 2. After the wireless radio frequency receiver 12 of the wireless communication device 1 is connected with the host 2, the paring program 13 in the host 2 is executed to actively read the device descriptor D1 from the wireless radio frequency receiver 12 and judge whether the Bluetooth transmission module 112 of the device body 11 has been paired with the Bluetooth transmission unit 22 of the host 2 according to the device descriptor D1. If the paring program 13 judges that the Bluetooth transmission module 112 of the device body 11 has been paired with the Bluetooth transmission unit 22 of the host 2, no action will be done. Meanwhile, the Bluetooth connection between the Bluetooth transmission module 112 of the device body 11 and the Bluetooth transmission unit 22 of the host 2 is directly established. Moreover, the device body 11 also issues a broadcasting information D2. If the paring program 13 judges that the Bluetooth transmission module 112 of the device body 11 has not been paired with the Bluetooth transmission unit 22 of the host 2, the paring program 13 performs a Bluetooth communication pairing process of paring the Bluetooth transmission unit 22 of the host 2 with the Bluetooth transmission module 112 of the device body 11 according to the device descriptor D1 and the broadcasting information D2.

Preferably but not exclusively, the broadcasting information D2 from the device body 11 includes a vendor identification code (VID) of the wireless communication device 1, a product identification code (PID), a product string, a serial number, a vendor-defined protocol, a Bluetooth (BT) address, or any other recognizable information. After the paring program 13 receives the broadcasting information D2 from the device body 11, the paring program 13 compares the broadcasting information D2 with the device descriptor D1. If at least a portion of the received broadcasting information D2 complies with at least a portion of the read device descriptor D1, the paring program 13 recognizes that the wireless communication device 1 is ready to be paired with the host 2. Then, the paring program 13 automatically enables a Bluetooth communication pairing process of paring the wireless communication device 1 with the host 2. After the Bluetooth communication pairing process is completed, the Bluetooth connection between the Bluetooth transmission module 112 of the device body 11 and the Bluetooth transmission unit 22 of the host 2 is established.

In an embodiment, the device body 11 issues the broadcasting information D2 when the device body 11 is in a Bluetooth communication mode. Preferably but not exclusively, the broadcasting information D2 is broadcasted from the device body 11 in one of the following three situations. In the first situation, the broadcasting information D2 is continuously broadcasted from the device body 11. In a second situation, the broadcasting information D2 is periodically broadcasted from the device body 11 at a predetermined time interval. In a third situation, the broadcasting information D2 is broadcasted from the device body 11 according to a prompt message from the paring program 13. For example, after the paring program 13 reads the device descriptor D1 from the wireless radio frequency receiver 12, a prompt window is shown on the host 2 to prompt the user. When the user views the prompt window and presses a key (not shown) of the device body 11, the device body 11 broadcasts the broadcasting information D2. For example, the device body 11 is originally in a wireless radio frequency communication mode. After the paring program 13 reads the device descriptor D1 from the wireless radio frequency receiver 12, the paring program 13 calls the device body 11 through wireless radio frequency communication. After the device body 11 is called, the wireless radio frequency communication mode is switched to a Bluetooth communication mode. Consequently, the broadcasting information D2 is broadcasted in the Bluetooth communication mode.

In an embodiment, a paired Bluetooth device list 23 is stored in the host 2. The paired Bluetooth device list 23 contains the recognizable information about the wireless communication devices that have been paired with the host 2. For example, the recognizable information includes the Bluetooth addresses. After the paring program 13 reads the device descriptor D1 from the wireless radio frequency receiver 12, the paring program 13 compares the device descriptor D1 with the paired Bluetooth device list 23. According to the comparing result, the paring program 13 realizes whether the recognizable information about the wireless communication device to be in Bluetooth connection with the host 2 is contained in the paired Bluetooth device list 23. If the recognizable information about the wireless communication device to be in Bluetooth connection with the host 2 is contained in the paired Bluetooth device list 23, it means that the wireless communication device has been successfully paired with the host 2. Whereas, if the recognizable information about the wireless communication device to be in Bluetooth connection with the host 2 is not contained in the paired Bluetooth device list 23, the wireless communication device has not been paired with the host 2.

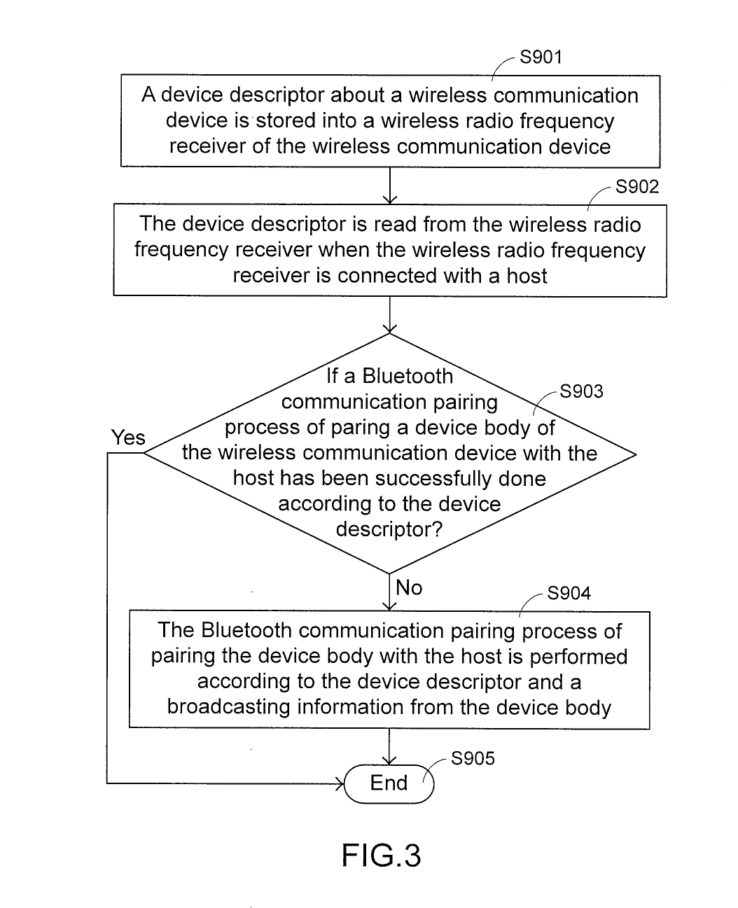

FIG. 3 is a flowchart illustrating a communication pairing method according to an embodiment of the present invention. The communication pairing method comprises the following steps.

In a step S901, a device descriptor D1 about a wireless communication device 1 is stored into a wireless radio frequency receiver 12 of the wireless communication device 1.

In the step S902, the device descriptor D1 is read from the wireless radio frequency receiver 12 when the wireless radio frequency receiver 12 is connected with a host 2.

In the step S903, the pairing program 13 judges whether a Bluetooth communication pairing process of paring a device body 11 of the wireless communication device 1 with the host 2 has been successfully done according to the device descriptor D1. If the pairing program 13 judges that the Bluetooth communication pairing process of pairing the device body 11 with the host 2 has been successfully done, a step S905 is performed. Whereas, if the pairing program 13 judges that the Bluetooth communication pairing process of pairing the device body 11 with the host 2 has not been successfully done, a step S904 is performed.

In a step S904, the Bluetooth communication pairing process of pairing the device body 11 with the host 2 is performed according to the device descriptor D1 and a broadcasting information D2 from the device body 11. In an example of the step S904, if at least a portion of the broadcasting information D2 complies with at least a portion of the device descriptor D1, the Bluetooth communication pairing process of pairing the device body 11 with the host 2 is performed.

In a step S905, the flowchart is ended.

From the above descriptions, the present invention provides the wireless communication device 1. The wireless communication device 1 is selectively operated in the wireless radio frequency communication mode or the Bluetooth communication mode according to the practical requirements of the user. The wireless radio frequency receiver 12 plugged into the host 2 receives the wireless radio frequency signal S1 from the device body 11 of the wireless communication device 1. In addition, a device descriptor D1 about the wireless communication device 1 is stored in the wireless radio frequency receiver 12. The paring program 13 installed in the host 2 is executed to actively acquire the device descriptor D1 of the wireless communication device 1 from the wireless radio frequency receiver 12. Consequently, the Bluetooth communication pairing process of paring the wireless communication device 1 with the host 2 is automatically executed. Since the manual operating behavior of the user is not required, the communication pairing method of the present invention is user-friendly. In other words, the communication pairing method of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A wireless communication device, comprising:
a device body comprising a wireless radio frequency transmission module and a Bluetooth transmission module;
a wireless radio frequency receiver connected with a host and receiving a wireless radio frequency signal from the wireless radio frequency transmission module, wherein a device descriptor about the device body is stored in the wireless radio frequency receiver; and
a paring program installed in the host, wherein after the wireless radio frequency receiver is connected with the host, the paring program is executed to actively read the device descriptor from the wireless radio frequency receiver and judge whether the Bluetooth transmission module has been paired with the host according to the device descriptor, wherein if the paring program judges that the Bluetooth transmission module has not been paired with the host, the paring program performs a Bluetooth communication pairing process of pairing the Bluetooth transmission module with the host according to the device descriptor and a broadcasting information from the device body.

2. The wireless communication device according to claim 1, wherein if the pairing program judges that at least a portion of the broadcasting information complies with at least a portion of the device descriptor, the paring program performs the Bluetooth communication pairing process of pairing the Bluetooth transmission module with the host.

3. The wireless communication device according to claim 1, wherein the broadcasting information is continuously broadcasted from the device body, or the broadcasting information is periodically broadcasted from the device body, or the broadcasting information is broadcasted from the device body according to a prompt message from the paring program.

4. The wireless communication device according to claim 3, wherein the device body is switched from a wireless radio frequency communication to a Bluetooth communication mode according to the prompt message from the paring program, and the broadcasting information is broadcasted when the device body is in the Bluetooth communication mode.

5. The wireless communication device according to claim 1, wherein the device descriptor includes at least one of a vendor identification code (VID) of the wireless communication device, a product identification code (PID), a product string, a serial number, a vendor-defined protocol and a Bluetooth (BT) address, or the broadcasting information includes at least one of a vendor identification code (VID) of the wireless communication device, a product identification code (PID), a product string, a serial number, a vendor-defined protocol and a Bluetooth (BT) address.

6. The wireless communication device according to claim 1, wherein the wireless radio frequency transmission module is a 2.4G wireless transmission module, and the Bluetooth transmission module is a Bluetooth low energy (BLE) transmission module.

7. The wireless communication device according to claim 1, wherein the wireless communication device is a mouse device, a keyboard device, a writing tablet, a camera device or a wearable device, or the host is a desktop computer, a notebook computer or a tablet computer.

8. A communication pairing method for pairing a device body of a wireless communication device with a host, the communication pairing method comprising steps of:
(a) storing a device descriptor about a wireless communication device into a wireless radio frequency receiver of the wireless communication device, wherein the wireless radio frequency receiver receives a wireless radio frequency signal from the device body;
(b) reading the device descriptor from the wireless radio frequency receiver when the wireless radio frequency receiver is connected with the host;
(c) judging whether a Bluetooth communication pairing process of paring the device body with the host has been successfully done according to the device descriptor; and
(d) if the Bluetooth communication pairing process of paring the device body with the host has not been successfully done, performing the Bluetooth communication pairing process of paring the device body with the host according to the device descriptor and a broadcasting information from the device body.

9. The communication pairing method according to claim 8, wherein if at least a portion of the broadcasting information complies with at least a portion of the device descriptor in the step (d), the Bluetooth communication pairing process of pairing the device body with the host is performed.

10. The communication pairing method according to claim 8, wherein in the step (d), the broadcasting information is continuously broadcasted from the device body, or the broadcasting information is periodically broadcasted from the device body, or the broadcasting information is broadcasted from the device body according to a prompt message from the paring program.

11. The communication pairing method according to claim 10, wherein the device body is switched from a wireless radio frequency communication to a Bluetooth communication mode according to the prompt message from the paring program, and the broadcasting information is broadcasted when the device body is in the Bluetooth communication mode.

12. The communication pairing method according to claim 8, wherein the device descriptor includes at least one of a vendor identification code (VID) of the wireless communication device, a product identification code (PID), a product string, a serial number, a vendor-defined protocol and a Bluetooth (BT) address, or the broadcasting information includes at least one of a vendor identification code (VID) of the wireless communication device, a product identification code (PID), a product string, a serial number, a vendor-defined protocol and a Bluetooth (BT) address.

13. The communication pairing method according to claim 8, wherein the wireless communication device is a mouse device, a keyboard device, a writing tablet, a camera device or a wearable device, or the host is a desktop computer, a notebook computer or a tablet computer.
